(19) United States
(12) Patent Application Publication
(10) Pub. No.: US 2016/0028267 A1
(43) Pub. Date: Jan. 28, 2016

(54) Wireless Charging Systems

(71) Applicant: Samsung Electronics Co., Ltd., Suwon-si (KR)

(72) Inventors: Jun-Ho Lee, Hwaseong-si (KR); Jung-Su Kim, Yongin-si (KR); Ki-Hyoun Kwon, Hwaseong-si (KR); Tong-Hun Kim, Suwon-si (KR); Em-Hwan Kim, Yongin-si (KR); Jang-Won Lee, Seongnam-si (KR); Jae-Hun Choe, Yongin-si (KR); Yoon-Young Kim, Hwaseong-si (KR); Sook-Hee Sung, Suwon-si (KR)

(21) Appl. No.: 14/728,490

(22) Filed: Jun. 2, 2015

(30) Foreign Application Priority Data
Jul. 23, 2014 (KR) 10-2014-0093285

(51) Int. Cl. H02J 7/02

(52) U.S. Cl. CPC H02J 7/025

(57) ABSTRACT

A wireless charging system includes a steering wheel including a wireless power transmission device that is configured to wirelessly transmit a wireless power signal based on a magnetic resonance technique or based on a magnetic induction technique and at least one wearable device including a wireless power reception device that is configured to wirelessly receive the wireless power signal to charge a battery included in the wearable device based on the wireless power signal.

### CROSS-REFERENCE TO RELATED APPLICATION(S)

This application claims priority under 35 USC §119 to Korean Patent Application No. 10-2014-0093285, filed on Jul. 23, 2014 in the Korean Intellectual Property Office (KIPO), the disclosure of which is incorporated by reference herein in its entirety.

### BACKGROUND

Example embodiments relate generally to a wireless charging technology. More particularly, embodiments of the present inventive concepts relate to a wireless charging system applicable to vehicles (e.g., a car).

Recently, portable electronic devices that users wear (i.e., a wearable device) have come into the spotlight. Generally, a wearable device (e.g., smart watch, etc) operates based on power supplied by a battery. However, since the wearable device has limits in size, weight, etc, it is difficult for the wearable device to include a high-capacity battery. That is, since a battery of the wearable device may need to be frequently charged (or, recharged), convenient charging of the battery of the wearable device may be desired. For example, if the user is required to take off the wearable device to charge the battery of the wearable device, a possibility that the user could lose the wearable device may be relatively high. In addition, since the user may be required to pay attention to the charging of the battery of the wearable device, it may be difficult for the use of the wearable device to become popular among consumers. Wireless charging technology may be classified into at least two types (i.e., a magnetic induction technology and a magnetic resonance technology). Here, the magnetic induction technology achieves relatively high charging efficiency, but has a relatively short maximum charging distance. In contrast, the magnetic resonance technology has a relatively long maximum charging distance, but achieves relatively low charging efficiency.

### SUMMARY

Some example embodiments provide wireless charging systems capable of efficiently charging wearable devices without user involvement when a user wearing the wearable device gets in a car (or, vehicle).

According to example embodiments of the present inventive concepts, a wireless charging system may include a steering wheel including a wireless power transmission device configured to wirelessly transmit a wireless power signal based on a magnetic resonance technique or based on a magnetic induction technique and a wearable device including a wireless power reception device configured to receive the wireless power signal in order to charge a battery included in the wearable device.

In example embodiments of the present inventive concepts, the wearable device may be implemented as a smart watch that a user wears.

In example embodiments of the present inventive concepts, the wearable device may be configured to provide a battery condition signal indicating a remaining battery level of the battery to the steering wheel. In addition, the wireless power transmission device may be configured to wirelessly transmit the wireless power signal to the wearable device when the remaining battery level of the battery is lower than a reference battery level.

In example embodiments of the present inventive concepts, the reference battery level may be set to be a maximum battery level of the battery.

In example embodiments of the present inventive concepts, the wearable device may be configured to provide a charging completion signal to the steering wheel when charging of the battery is completed. In addition, the wireless power transmission device may be configured to not wirelessly transmit the wireless power signal to the wearable device when the charging completion signal is received from the wearable device.

In example embodiments of the present inventive concepts, the wireless power transmission device may be configured to wirelessly transmit the wireless power signal to the wearable device based on the magnetic resonance technique when a distance between the car steering wheel and the wearable device is greater than a reference distance.

In example embodiments of the present inventive concepts, the wireless power transmission device may be configured to wirelessly transmit the wireless power signal to the wearable device based on the magnetic induction technique when the distance between the steering wheel and the wearable device is shorter than the reference distance.

In example embodiments of the present inventive concepts, the reference distance may be set to a distance between the car steering wheel and the wearable device at a time when a user wearing the wearable device grips the steering wheel.

In example embodiments of the present inventive concepts, the wireless power transmission device may be configured to wirelessly transmit the wireless power signal to the wearable device when a charging permission response signal is received from the wearable device responsive to a charging permission check signal provided by the wireless power transmission device to the wearable device.

In example embodiments of the present inventive concepts, the wearable device may be a plurality of wearable devices. In addition, the car steering wheel may be configured to wirelessly transmit the wireless power signal to target wearable devices that are selected among the plurality of wearable devices.

In example embodiments of the present inventive concepts, a number of the target wearable devices may be smaller than a maximum number of wearable devices that can be wirelessly charged by the steering wheel.

In example embodiments of the present inventive concepts, the wireless power transmission device may be configured to simultaneously wirelessly transmit the wireless power signal to the target wearable devices.

In example embodiments of the present inventive concepts, the wireless power transmission device may be configured to sequentially wirelessly transmit the wireless power signal to the target wearable devices.

In example embodiments of the present inventive concepts, the wireless power transmission device may be configured to sequentially wirelessly transmit the wireless power signal to the target wearable devices in ascending order of remaining battery levels of batteries included in the target wearable devices.

In example embodiments of the present inventive concepts, the wireless power transmission device may be configured to sequentially wirelessly transmit the wireless power signal to the target wearable devices in descending order of priorities of the target wearable devices.

According to example embodiments of the present inventive concepts, a wireless charging system may include a steering wheel for a vehicle including a wireless power transmission device. The wireless transmission device may be configured to wirelessly transmit a wireless power signal to an electronic device. The wireless power transmission device can further include a wireless power signal generation unit, a transmission matching unit, and a wireless power signal transmission control unit. The wireless power signal generation unit can be configured to generate a power signal for transmission to the electronic device. The transmission matching unit can be configured to wirelessly transmit the wireless power signal to the electronic device using a magnetic resonance technique or using a magnetic induction technique. The wireless power signal transmission control unit can be configured to control the wireless power signal generation unit and the transmission matching unit.

In example embodiments of the present inventive concepts, the wireless power transmission device can be further configured to receive signals from and transmit signals to the electronic device.

In example embodiments of the present inventive concepts, the electronic device can be a plurality of electronic devices. The wireless power transmission device can be configured to wirelessly transmit the wireless power signal to target electronic devices that are selected among the plurality of electronic devices.

In example embodiments of the present inventive concepts, the wireless power transmission device can be configured to simultaneously wirelessly transmit the wireless power signal to the target electronic devices.

In example embodiments of the present inventive concepts, the wireless power transmission device can be configured to sequentially wirelessly transmit the wireless power signal to the target electronic devices.

In example embodiments of the present inventive concepts, the wireless power transmission device can be configured to sequentially wirelessly transmit the wireless power signal to the target electronic devices in an order based on the remaining battery levels of batteries included in the target electronic devices.

In example embodiments of the present inventive concepts, the wireless power transmission device can be configured to sequentially wirelessly transmit the wireless power signal to the target electronic devices in order based on a priority of the target electronic devices.

In example embodiments of the present inventive concepts, the wireless power transmission device can be further configured to transmit a charging permission check signal to the electronic device and to begin wirelessly transmitting a wireless power signal to the electronic device after receiving from the electronic device a charging permission response signal responsive to the charging permission check signal.

In example embodiments of the present inventive concepts, the wireless power transmission device can be further configured to determine a distance between the steering wheel of the vehicle and the electronic device. The wireless power transmission mode used to wirelessly charge the electronic device can be selected from a plurality of wireless power transmission modes based on the determined distance between the steering wheel of the vehicle and the electronic device.

According to example embodiments of the present inventive concepts, a wireless charging system can include a wearable device including a wireless power reception device configured to wirelessly receive a wireless power signal from a wireless power transmission device in a vehicle in order to charge a battery included in the wearable device. The wireless power reception device can include a reception matching unit and a wireless power signal reception control unit. The reception matching unit can be configured to wirelessly receive the wireless power signal from the wireless power transmission device in the vehicle using a magnetic resonance technique or using a magnetic induction technique. The wireless power signal reception control unit can be configured to control the reception matching unit.

In example embodiments of the present inventive concepts, the wireless power reception device can be further configured to receive signals from and transmit signals to the wireless power transmission device in a steering wheel of the vehicle.

In example embodiments of the present inventive concepts, the wireless power reception device can be further configured to provide a charging permission response signal responsive to a charging permission check signal from the power transmission device in the steering wheel of the vehicle.

In example embodiments of the present inventive concepts, the wireless power reception device can be further configured to provide a battery condition signal responsive to a battery condition check signal from the power transmission device in the steering wheel of the vehicle.

Therefore, wireless charging systems according to example embodiments of the present inventive concepts may efficiently charge a wearable device without user involvement when a user wearing the wearable device gets in a car (or, vehicle). Here, the wireless charging systems may simultaneously or sequentially charging a plurality of wearable devices, may selectively charging the wearable devices, and/or may change a wireless charging mode based on a distance between a car steering wheel and the wearable device.

### BRIEF DESCRIPTION OF THE DRAWINGS

Illustrative, non-limiting example embodiments of the present inventive concepts will be more clearly understood from the following detailed description in conjunction with the accompanying drawings.

FIG. 1 is a diagram illustrating wireless charging systems according to example embodiments of the present inventive concepts.

FIG. 2 is a block diagram illustrating an example of the wireless charging systems of FIG. 1.

FIG. 3 is a flowchart illustrating an example in which the wireless charging systems of FIG. 1 determine whether to charge a battery of a wearable device.

FIG. 4 is a diagram illustrating an example in which the wireless charging systems of FIG. 1 determine whether to charge a battery of a wearable device.

FIG. 5 is a flowchart illustrating an example in which the wireless charging systems of FIG. 1 change a wireless charging mode based on a distance between a steering wheel and a wearable device.

FIG. 6 is a diagram illustrating an example in which the wireless charging systems of FIG. 1 change a wireless charging mode based on a distance between a steering wheel and a wearable device.

FIG. 7 is a flowchart illustrating an example in which the wireless charging systems of FIG. 1 simultaneously or sequentially charge a plurality of wearable devices.

FIG. 8 is a diagram illustrating an example in which the wireless charging systems of FIG. 1 simultaneously or sequentially charge a plurality of wearable devices.

FIG. 9 is a flowchart illustrating an example in which the wireless charging systems of FIG. 1 sequentially charge a plurality of wearable devices based on the remaining battery levels of batteries included in the wearable devices.

FIG. 10 is a diagram illustrating an example in which the wireless charging systems of FIG. 1 sequentially charge a plurality of wearable devices based on the remaining battery levels of batteries included in the wearable devices.

FIG. 11 is a flowchart illustrating an example in which the wireless charging systems of FIG. 1 sequentially charge a plurality of wearable devices based on a priority of the wearable devices.

FIG. 12 is a diagram illustrating an example in which the wireless charging systems of FIG. 1 sequentially charge a plurality of wearable devices based on the priority of the wearable devices.

FIG. 13 is a flowchart illustrating an example in which the wireless charging systems of FIG. 1 selectively charge a plurality of wearable devices.

FIG. 14 is a diagram illustrating an example in which the wireless charging systems of FIG. 1 selectively charge a plurality of wearable devices.

FIG. 15 is a block diagram illustrating wearable devices according to example embodiments of the present inventive concepts.

FIG. 16 is a diagram illustrating an example in which the wearable devices of FIG. 15 are implemented as a smart watch.

### DETAILED DESCRIPTION OF THE EMBODIMENTS

Various example embodiments will be described more fully with reference to the accompanying drawings, in which some example embodiments of the present inventive concepts are shown. The present inventive concepts may, however, be embodied in many different forms and should not be construed as limited to the embodiments set forth herein. Rather, these embodiments are provided so that this disclosure will be thorough and complete, and will fully convey the scope of the present inventive concepts to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the present inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which these present inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

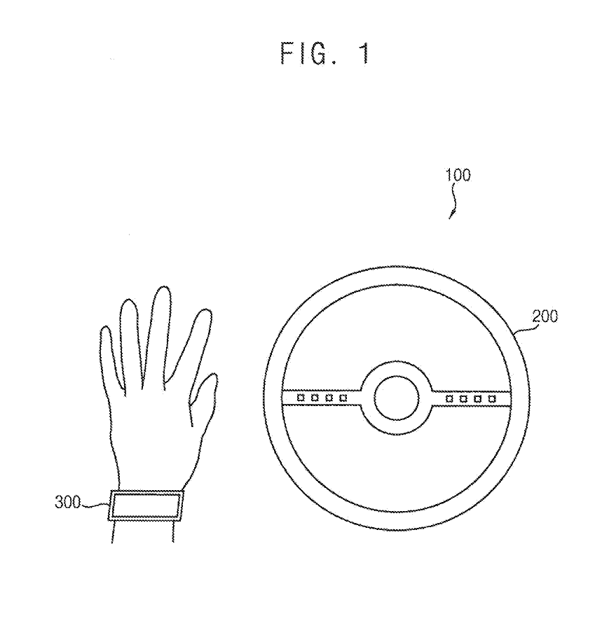

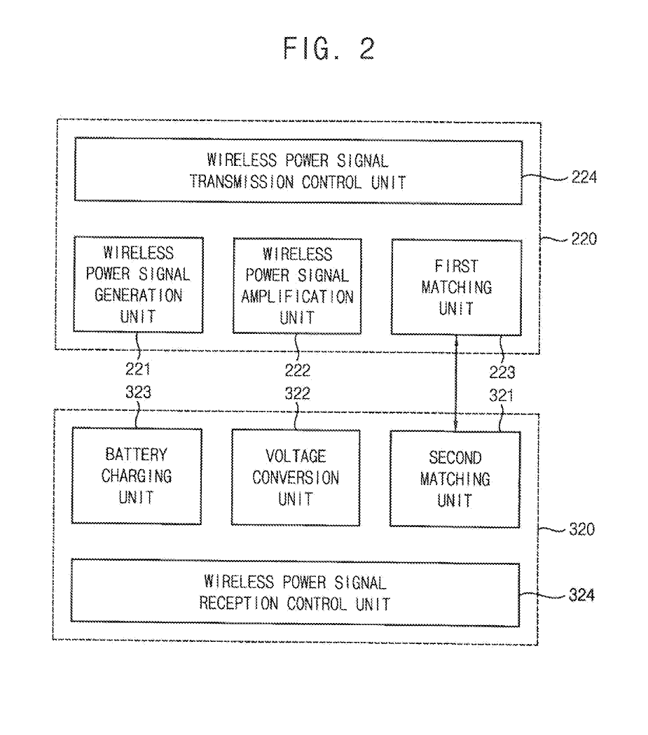

FIG. 1 is a diagram illustrating wireless charging systems according to example embodiments of the present inventive concepts. FIG. 2 is a block diagram illustrating an example of the wireless charging systems of FIG. 1.

Referring to FIGS. 1 and 2, the wireless charging system 100 may include a car steering wheel 200 and at least one wearable device 300. Here, the car steering wheel 200 may include a wireless power transmission device 220, and the wearable device 300 may include a wireless power reception device 320. Though the example embodiments are directed to a car, a person of ordinary skill in the art will understand that the present inventive concepts described herein could be readily adapted for other vehicles without limitation. The car steering wheel 200 can be any device used to direct the vehicle in response to user input.

The car steering wheel 200 may include the wireless power transmission device 220 that wirelessly transmits a wireless power signal to the wearable device 300 based on a magnetic resonance technique or based on a magnetic induction technique. In addition, the wearable device 300 may include the wireless power reception device 320 that receives the wireless power signal from the car steering wheel 200 to charge a battery of the wearable device 300. That is, the wireless charging system 100 may charge the wearable device 300 by using the wireless power transmission device 220 (e.g., referred to as a wireless charger) included in the car steering wheel 200. In this specification, it should be understood that charging the wearable device 300 means charging the battery included in the wearable device 300. Similarly, it should be understood that charging the wearable device 300 by the car steering wheel 200 means that the wireless power transmission device 220 within the car steering wheel 200 wirelessly transmits a power signal to the wearable device 300. In example embodiments of the present inventive concepts, the wearable device 300 may be a smart watch worn by a user (e.g., on the wrist). However, the wearable device 300 is not limited thereto. The wearable device 300 may be any portable electronic device which is closely associated with a user, such as a smart phone, which may be carried by the user. Generally, compared to portable electronic devices such as a cellular phone, a smart phone, a smart pad, etc, the wearable device 300 may be more inconvenient to the user if the user is required to take off the wearable device 300 to charge the wearable device 300. This is because the wearable device 300 is designed to be used while being worn. For this reason, the wireless charging system 100 may increase user convenience by efficiently charging the wearable device 300 without any user involvement when the user gets in a car (or, vehicle). That is, the wireless charging system 100 may charge the wearable device 300 in situ and enable the user to avoid taking off the wearable device 300 and connecting the wearable device 300 to a specific charger to charge the wearable device 300 when the user gets in the car.

Specifically, the wireless power transmission device 220 included in the car steering wheel 200 may include a wireless power signal generation unit 221, a wireless power signal amplification unit 222, a first matching unit 223, and a wireless power signal transmission control unit 224. The wireless power signal generation unit 221 may generate a wireless power signal for charging the battery of the wearable device 300. Here, the wireless power signal generation unit 221 may receive power for generating the wireless power signal from a battery or other power source included in a car (or, vehicle). The wireless power signal amplification unit 222 may amplify intensity of the wireless power signal to properly transmit the wireless power signal to the wireless power reception device 320 of the wearable device 300. That is, the wireless power signal amplification unit 222 may improve efficiency of wireless power transmission by amplifying the intensity of the wireless power signal. In some example embodiments of the present inventive concepts, the wireless power transmission device 220 may not include the wireless power signal amplification unit 222. The first matching unit 223 may wirelessly transmit the wireless power signal to the wireless power reception device 320 included in the wearable device 300. In some example embodiments of the present inventive concepts, the first matching unit 223 may include LC circuits to wirelessly transmit the wireless power signal to the second matching unit 321 based on electromagnetic fields. Here, since the wireless power transmission device 220 can be located in the car steering wheel 200, a wire corresponding to an antenna for wireless transmission, where the wire is included in (or, coupled to) the first matching unit 223, may be coiled around the car steering wheel 200 (e.g., a circle-shaped handle). Thus, compared to a case in which the wireless power transmission device 220 is located in other parts of the car other than the car steering wheel 200, a length of the wire may be relatively long in a case in which the wireless power transmission device 220 is located in the car steering wheel 200. As a result, the wireless power transmission device 220 may secure a relatively sufficient maximum charging distance. Nevertheless, in some example embodiments of the present inventive concepts, the wireless power transmission device 220 may be located in various parts of the car. In example embodiments of the present inventive concepts, the wireless power transmission device 220 may be located in any portion of a vehicle which is configured to maintain a substantially fixed position relative to an occupant of the vehicle during operation. For example, the wireless power transmission device 220 may be located in a gear shift lever. In this case, the wire corresponding to the antenna for the wireless transmission may be coiled around the gear shift lever. For example, the wireless power transmission device 220 may be located in a seat. In this case, the wire corresponding to the antenna for the wireless transmission may be coiled around a portion of the car seat. However, a location of the wireless power transmission device 220 and a location of the wire corresponding to the antenna for the wireless transmission are not limited thereto. The wireless power signal transmission control unit 224 may control the wireless power signal generation unit 221, the wireless power signal amplification unit 222, and the first matching unit 223.

The wireless power reception device 320 included in the wearable device 300 may include a second matching unit 321, a voltage conversion unit 322, a battery charging unit 323, and a wireless power signal reception control unit 324. The second matching unit 321 may wirelessly receive the wireless power signal from the wireless power transmission device 220 included in the car steering wheel 200. In example embodiments of the present inventive concepts, the second matching unit 321 may include LC circuits to wirelessly receive the wireless power signal from the first matching unit 223 based on electromagnetic fields. The voltage conversion unit 322 may convert the wireless power signal (i.e., alternating current [AC] signal) received from the second matching unit 321 into a direct current (DC) signal for the battery charging unit 323 to charge the battery of the wearable device 300. The battery charging unit 323 may charge the battery of the wearable device 300 based on the DC signal received from the voltage conversion unit 322. For this operation, the battery charging unit 323 may include, for example, a voltage regulator, a DC-DC converter, etc. The wireless power signal reception control unit 324 may control the second matching unit 321, the voltage conversion unit 322, and the battery charging unit 323. Meanwhile, to perform the above wireless charging operation, the wireless power signal transmission control unit 224 of the wireless power transmission device 220 included in the car steering wheel 200 may communicate with the wireless power signal reception control unit 324 of the wireless power reception device 320 included in the wearable device 300.

In some example embodiments of the present inventive concepts, the wearable device 300 (i.e., the wireless power signal reception control unit 324 of the wireless power reception device 320) may provide a battery condition signal indicating a remaining battery level of the battery of the wearable device 300 to the car steering wheel 200. Then, the car steering wheel 200 (i.e., the wireless power signal transmission control unit 224 of the wireless power transmission device 220) may wirelessly transmit the wireless power signal to the wearable device 300 when the remaining battery level of the battery included in the wearable device 300 is lower than a reference battery level. Here, the car steering wheel 200 (i.e., the wireless power signal transmission control unit 224 of the wireless power transmission device 220) may provide a battery condition check signal requesting the battery condition signal to the wearable device 300 (i.e., the wireless power signal reception control unit 324 of the wireless power reception device 320) before the wearable device 300 provides the battery condition signal indicating the remaining battery level of the battery in the wearable device 300 to the car steering wheel 200. For example, the reference battery level may be set to a maximum battery level of the battery included in the wearable device 300. However, the reference battery level is not limited to the maximum battery level of the battery included in the wearable device 300. That is, the reference battery level may be determined in various ways according to requirements of the wireless charging system 100. In other example embodiments of the present inventive concepts, the wearable device 300 (i.e., the wireless power signal reception control unit 324 of the wireless power reception device 320) may provide a charging completion signal to the car steering wheel 200 (i.e., the wireless power signal transmission control unit 224 of the wireless power transmission device 220) when the battery charging is completed (e.g., when the battery in the wearable device 300 is fully charged). In addition, the car steering wheel 200 may not wirelessly transmit the wireless power signal to the wearable device 300 when the charging completion signal is received from the wearable device 300. In other words, the car steering wheel 200 may stop the battery charging operation when the charging completion signal is received from the wearable device 300.

The charging completion signal may be exchanged between the wireless power transmission device 220 of the car steering wheel 200 and the wireless power reception device 320 of the wearable device 300 via the wireless power signal. In other words, the signal may be modulated in the wireless power signal such that the signal content can be extracted by the wireless power transmission device 220 and the wireless power reception device 320. However, embodiments of the present inventive concepts are not limited thereto. A person skilled in the art will recognize that signals can be exchanged between the wireless power transmission device 220 of the car steering wheel 200 and the wireless power reception device 320 of the wearable device 300 in multiple ways. For example, the signals could be exchanged via Bluetooth, wireless networking, or via Near Field Communication (NFC) to name just a few.

In example embodiments of the present inventive concepts, a plurality of wearable devices 300 may be located within (or, moved into) a maximum charging distance of the car steering wheel 200. In this case, the car steering wheel 200 may wirelessly transmit the wireless power signal to target wearable devices 300 that are selected among the plurality of wearable devices 300. For example, the number of the target wearable devices 300 that are selected among the wearable devices 300 may be smaller than a maximum number of wearable devices 300 that could be charged. In example embodiments of the present inventive concepts, the car steering wheel 200 may simultaneously (or, concurrently) transmit the wireless power signal to the target wearable devices 300. In this case, since the batteries of the target wearable devices 300 are simultaneously charged based on the wireless power signal received from the car steering wheel 200, low speed charging may be performed for batteries of the target wearable devices 300. In other example embodiments of the present inventive concepts, the car steering wheel 200 may sequentially transmit the wireless power signal to the target wearable devices 300. In this case, since the batteries of the target wearable devices 300 are sequentially charged based on the wireless power signal received from the car steering wheel 200, high speed charging may be performed for batteries of the target wearable devices 300. However, since the batteries of the target wearable devices 300 are sequentially charged, the car steering wheel 200 needs to determine an order of transmitting the wireless power signal to the target wearable devices 300. For example, the car steering wheel 200 may sequentially transmit the wireless power signal to the target wearable devices 300 in ascending order of the remaining battery levels of the batteries included in the target wearable devices 300. For example, the car steering wheel 200 may sequentially transmit the wireless power signal to the target wearable devices 300 in descending order of the priorities of the target wearable devices 300. However, a way that the car steering wheel 200 determines an order of transmitting the wireless power signal to the target wearable devices 300 is not limited thereto.

In order to sequentially charge the batteries of the target wearable devices 300, the wireless power transmission device 220 of the car steering wheel 200 and the wireless power reception devices 320 of the target wearable devices 300 may communicate to provide for one of the target wearable devices 300 to charge while another of the target wearable devices 300 waits. Similarly, in order to simultaneously charge the batteries of the target wearable devices 300 from among a plurality of wearable devices 300, the wireless power transmission device 220 of the car steering wheel 200 and the wireless power reception device 320 of the wearable devices 300 may communicate to provide for which of the plurality of wearable devices 300 were selected as target wearable devices 300 to be wirelessly charged. A person skilled in the art would recognize that such communication mechanisms can be accomplished via signals sent between the target wearable devices 300 and the car steering wheel 200. For example, the communication could be exchanged via signals such as Bluetooth, wireless networking, or via Near Field Communication (NFC) to name just a few. However, the communication mechanism is not limited thereto.

As described above, the car steering wheel 200 may wirelessly transmit the wireless power signal to the wearable device 300 based on at least the magnetic resonance technique or based on the magnetic induction technique. Here, a wireless charging mode in which the car steering wheel 200 wirelessly transmits the wireless power signal to the wearable device 300 based on the magnetic resonance technique may be referred to as a magnetic resonance mode. In addition, a wireless charging mode in which the car steering wheel 200 wirelessly transmits the wireless power signal to the wearable device 300 based on the magnetic induction technique may be referred to as a magnetic induction mode. Though the magnetic resonance mode and the magnetic induction mode are considered herein, a person of ordinary skill in the art will recognize that other wireless power transmission modes are possible. The present inventive concepts are not limited to the magnetic induction mode and the magnetic resonance mode.

In example embodiments of the present inventive concepts, when a distance between the car steering wheel 200 and the wearable device 300 is greater than a reference distance, the car steering wheel 200 may wirelessly transmit the wireless power signal to the wearable device 300 based on a first mode. For example, the first mode may be the magnetic resonance technique (i.e., the magnetic resonance mode). On the other hand, when the distance between the car steering wheel 200 and the wearable device 300 is shorter than the reference distance, the car steering wheel 200 may wirelessly transmit the wireless power signal to the wearable device 300 based on a second mode. For example, the second mode may be the magnetic induction technique (i.e., the magnetic induction mode). For example, the reference distance may be set to a distance between the car steering wheel 200 and the wearable device 300 when a user wearing the wearable device 300 on the wrist grips the car steering wheel 200. However, the reference distance is not limited thereto. That is, the reference distance may be determined in various ways according to requirements of the wireless charging system 100.

The distance between the car steering wheel 200 and the wearable device 300 may be determined in various ways. For example, the wireless power transmission device 220 of the car steering wheel 200 may estimate the distance between the car steering wheel 200 and the wearable device 300 based on the efficiency of the wireless power signal transmission. Similarly, the car steering wheel 200 may estimate the distance between the car steering wheel 200 and the wearable device 300 based on the strength of signals shared between them. Also, the car steering wheel 200 may estimate the distance between the car steering wheel 200 and the wearable device 300 based on measurements provided by other sensors within the vehicle. However, methods of determining the distance between the car steering wheel 200 and the wearable device 300 are not limited thereto.

After the car steering wheel 200 (i.e., the wireless power signal transmission control unit 224 of the wireless power transmission device 220) provides a charging permission check signal to the wearable device 300, the car steering wheel 200 may wirelessly transmit the wireless power signal to the wearable device 300 when a charging permission response signal is received from the wearable device 300 (i.e., the wireless power signal reception control unit 324 of the wireless power reception device 320). In this case, the car steering wheel 200 may wirelessly transmit the wireless power signal to the wearable devices 300 having charging permission (e.g., advance registration, payment, etc).

In brief, the wireless charging system 100 may efficiently charge the wearable device 300 without any user involvement when a user wearing the wearable device 300 gets in the car (or, vehicle). Here, the wireless charging system 100 may simultaneously or sequentially charge the wearable devices 300, may selectively charge the wearable devices 300, and/or may change a wireless charging mode based on the distance between the car steering wheel 200 and the wearable device 300. Although it is described above that the car steering wheel 200 wirelessly transmits the wireless power signal to the wearable device 300 based on the magnetic resonance technique or based on the magnetic induction technique, the car steering wheel 200 may wirelessly transmit the wireless power signal to the wearable device 300 only based on the magnetic resonance technique or may wirelessly transmit the wireless power signal to the wearable device 300 only based on the magnetic induction technique. Alternatively, the car steering wheel 200 may wirelessly transmit the wireless power signal to the wearable device 300 based on other wireless power transmission techniques, according to requirements of the wireless charging system 100. In addition, although it is illustrated in FIG. 1 that the wearable device 300 is implemented as a smart watch that a user can wear on the wrist, the wearable device 300 is not limited thereto. For example, the wearable device 300 may be implemented as a headset, glasses, etc as well as the smart watch. That is, the wearable device 300 should be interpreted as a portable electronic device that the user can wear.

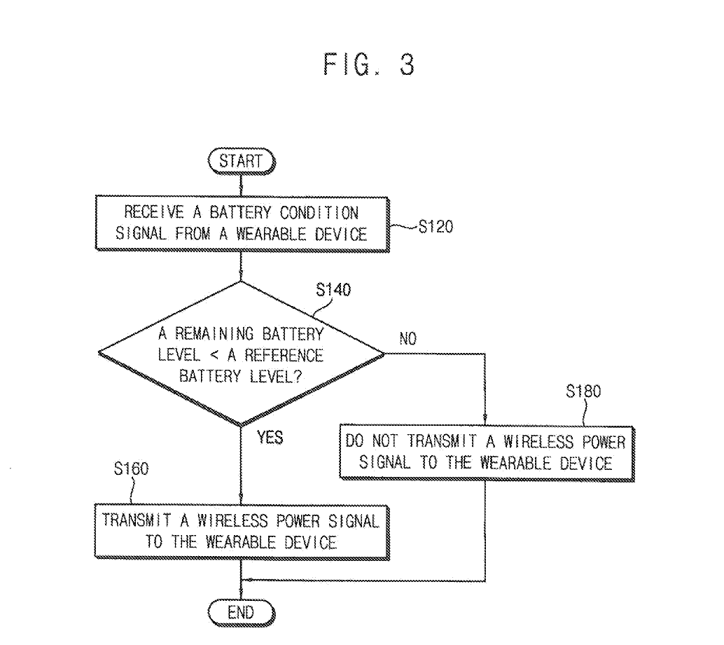

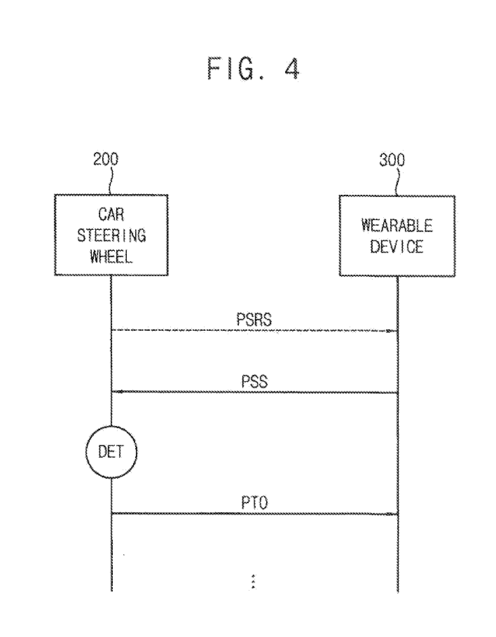

FIG. 3 is a flowchart illustrating an example in which the wireless charging systems of FIG. 1 determine whether to charge a wearable device 300. FIG. 4 is a diagram illustrating an example in which the wireless charging systems of FIG. 1 determine whether to charge a wearable device 300.

Referring to FIGS. 3 and 4, the wearable device 300 may provide the car steering wheel 200 with a battery condition signal PSS indicating a remaining battery level of the battery included in the wearable device 300, and the car steering wheel 200 may wirelessly transmit a wireless power signal PTO to the wearable device 300 only when the remaining battery level is lower than a reference battery level. Specifically, the car steering wheel 200 may receive the battery condition signal PSS from the wearable device 300 (S120) and may check whether the remaining battery level is lower than the reference battery level based on the battery condition signal PSS (i.e., indicated as DET in FIG. 4) (S140). For example, the reference battery level may be set to be a maximum battery level of the battery included in the wearable device 300. However, the reference battery level is not limited to the maximum battery level of the battery included in the wearable device 300. That is, the reference battery level may be determined in various ways according to requirements of the wireless charging system 100. Here, when the remaining battery level is lower than the reference battery level, the car steering wheel 200 may wirelessly transmit the wireless power signal PTO to the wearable device 300 (S160). On the other hand, when the remaining battery level is greater than the reference battery level, the car steering wheel 200 may not wirelessly transmit the wireless power signal PTO to the wearable device 300 (S180). In some example embodiments of the present inventive concepts, when the wearable device 300 is moved within a maximum charging distance of the car steering wheel 200, the car steering wheel 200 may provide a battery condition check signal PSRS requesting the battery condition signal PSS to the wearable device 300, and the wearable device 300 may provide the battery condition signal PSS to the car steering wheel 200 in response to the battery condition check signal PSRS. In brief, the wireless charging system 100 may efficiently charge the wearable device 300 when charging the battery included in the wearable device 300 is required when a user wearing the wearable device 300 gets in a car (or, vehicle).

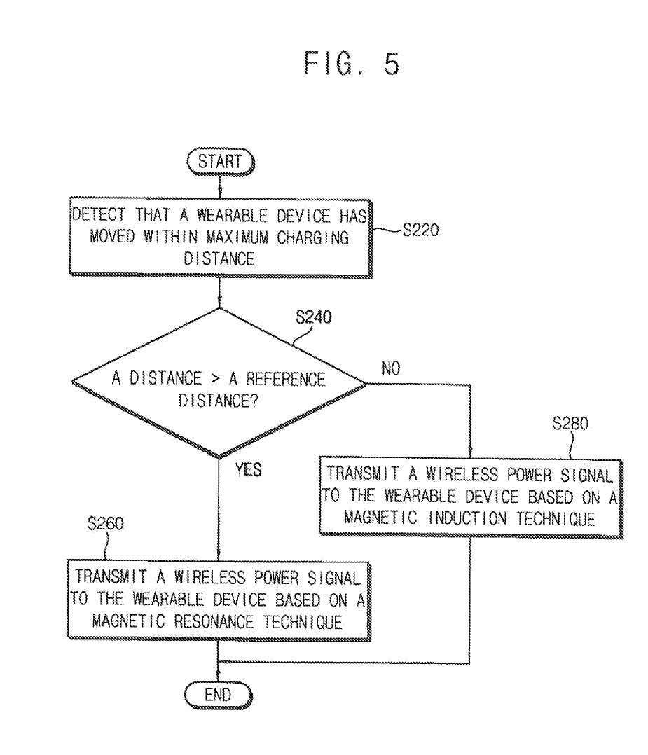

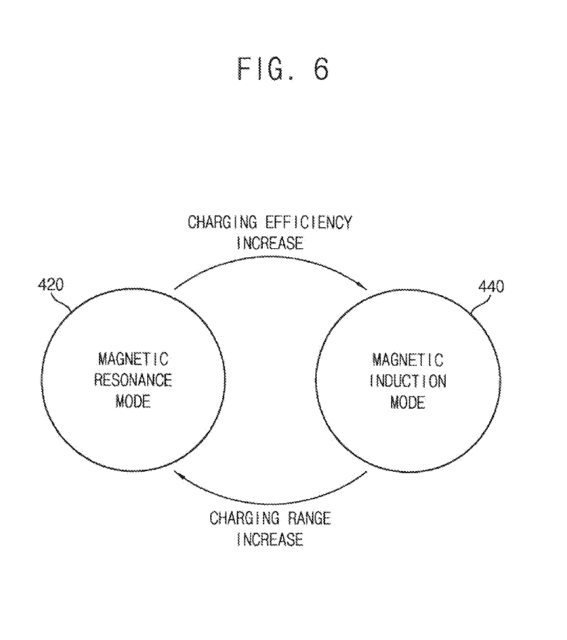

FIG. 5 is a flowchart illustrating an example in which the wireless charging systems of FIG. 1 change a wireless charging mode based on a distance between a steering wheel 200 and a wearable device 300. FIG. 6 is a diagram illustrating an example in which the wireless charging systems of FIG. 1 change a wireless charging mode based on a distance between a steering wheel 200 and a wearable device 300.

Referring to FIGS. 5 and 6, the car steering wheel 200 may wirelessly transmit a wireless power signal to the wearable device 300 based on a magnetic resonance technique (i.e., a magnetic resonance mode 420) or may wirelessly transmit the wireless power signal to the wearable device 300 based on a magnetic induction technique (i.e., a magnetic induction mode 440). Specifically, the car steering wheel 200 may detect that the wearable device 300 is moved within a maximum charging distance of the car steering wheel 200 (S220) and may check whether a distance between the car steering wheel 200 and the wearable device 300 is longer than a reference distance (S240). For example, the reference distance may be set to be a distance between the car steering wheel 200 and the wearable device 300 at a time when a user wearing the wearable device 300 on the wrist grips the car steering wheel 200. However, the reference distance is not limited thereto. That is, the reference distance may be determined in various ways according to requirements of the wireless charging system 100.

When the distance between the car steering wheel 200 and the wearable device 300 is greater than the reference distance, the car steering wheel 200 may wirelessly transmit the wireless power signal to the wearable device 300 based on the magnetic resonance technique (S260). That is, the car steering wheel 200 may charge a battery of the wearable device 300 in the magnetic resonance mode 420. Thus, a charging range (i.e., maximum charging distance) of the car steering wheel 200 may be increased. Generally, the magnetic resonance technique has a relatively long maximum charging distance, but achieves relatively low charging efficiency. For this reason, when the distance between the car steering wheel 200 and the wearable device 300 is greater than the reference distance, the car steering wheel 200 may charge the battery of the wearable device 300 in the magnetic resonance mode 420.

On the other hand, when the distance between the car steering wheel 200 and the wearable device 300 is shorter than the reference distance, the car steering wheel 200 may wirelessly transmit the wireless power signal to the wearable device 300 based on the magnetic induction technique (S280). That is, the car steering wheel 200 may charge a battery of the wearable device 300 in the magnetic induction mode 440. Thus, the battery included in the wearable device 300 may be efficiently charged. Generally, the magnetic induction technique achieves relatively high charging efficiency, but has a relatively short maximum charging distance. For this reason, when the distance between the car steering wheel 200 and the wearable device 300 is shorter than the reference distance, the car steering wheel 200 may charge the battery of the wearable device 300 in the magnetic induction mode 440. In brief, the wireless charging system 100 may change a wireless charging mode based on the distance between the car steering wheel 200 and the wearable device 300.

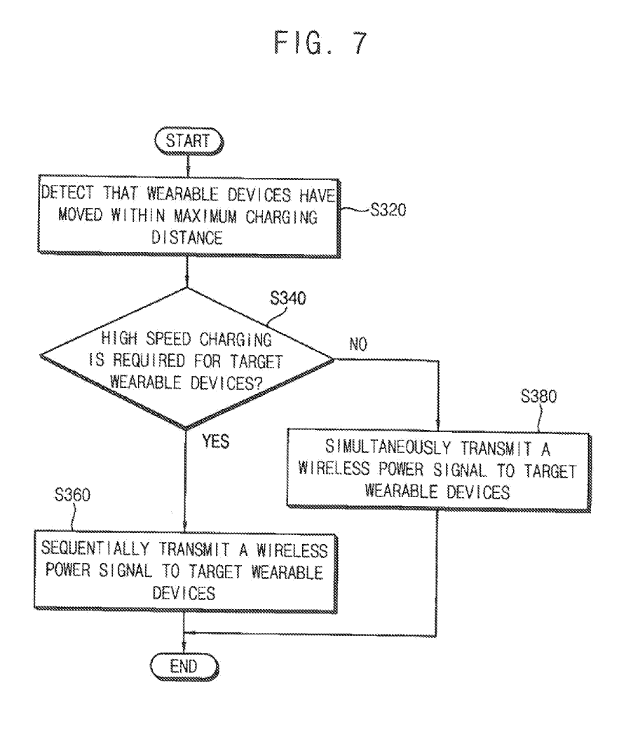

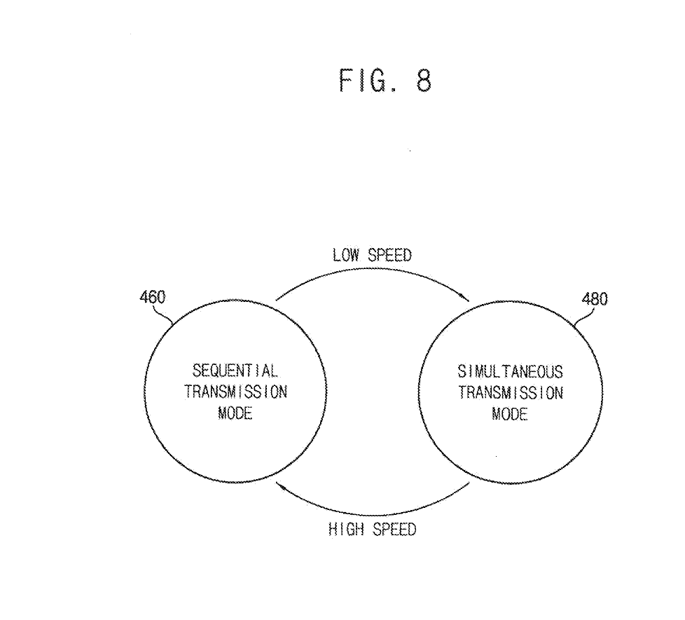

FIG. 7 is a flowchart illustrating an example in which the wireless charging systems of FIG. 1 simultaneously or sequentially charge a plurality of wearable devices 300. FIG. 8 is a diagram illustrating an example in which the wireless charging systems of FIG. 1 simultaneously or sequentially charge a plurality of wearable devices 300.

Referring to FIGS. 7 and 8, when a plurality of wearable devices 300 are located within a maximum charging distance of the car steering wheel 200, the car steering wheel 200 may sequentially charge the wearable devices 300 (i.e., a sequential transmission mode 460) or may simultaneously charge the wearable devices 300 (i.e., a simultaneous transmission mode 480). Specifically, the car steering wheel 200 may detect that the wearable devices 300 are moved within the maximum charging distance of the car steering wheel 200 (S320) and may check whether high speed charging is required for target wearable devices 300 that are selected among the plurality of wearable devices 300 (S340). As described above, the car steering wheel 200 may wirelessly transmit a wireless power signal to the target wearable devices 300. For example, the number of the target wearable devices 300 that are selected among the wearable devices 300 may be smaller than a maximum number of wearable devices 300 that could be charged. Here, when the high speed charging is required for the target wearable devices 300, the car steering wheel 200 may sequentially transmit the wireless power signal to the target wearable devices 300 (S360). In this case, since batteries of the target wearable devices 300 are sequentially charged based on the wireless power signal received from the car steering wheel 200, the high speed charging may be performed for batteries of the target wearable devices 300 in the sequential transmission mode 460. On the other hand, when high speed charging is not required for the target wearable devices 300, the car steering wheel 200 may simultaneously transmit the wireless power signal to the target wearable devices 300 (S380). In this case, since the batteries of the target wearable devices 300 are simultaneously charged based on the wireless power signal received from the car steering wheel 200, low speed charging may be performed for batteries of the target wearable devices 300 in the simultaneous transmission mode 480. In brief, the wireless charging system 100 may sequentially or simultaneously charge the target wearable devices 300 that are selected among the plurality of wearable devices 300. Meanwhile, since the batteries of the target wearable devices 300 are sequentially charged in the sequential transmission mode 460, the car steering wheel 200 may determine an order of transmitting the wireless power signal to the target wearable devices 300 according to a predetermined criterion.

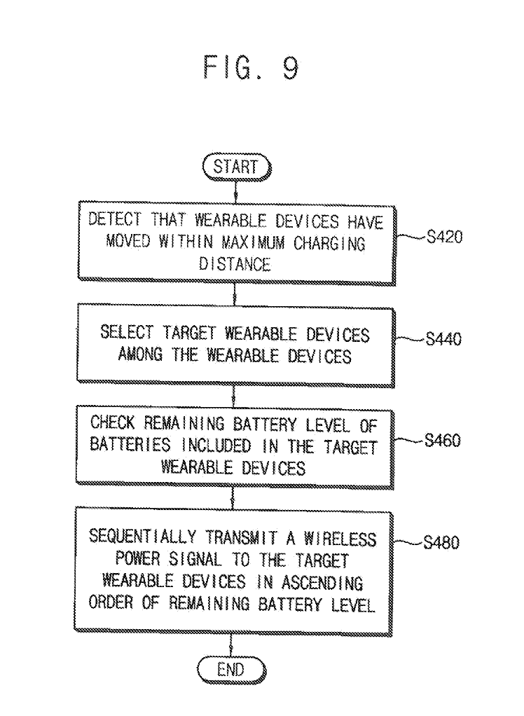

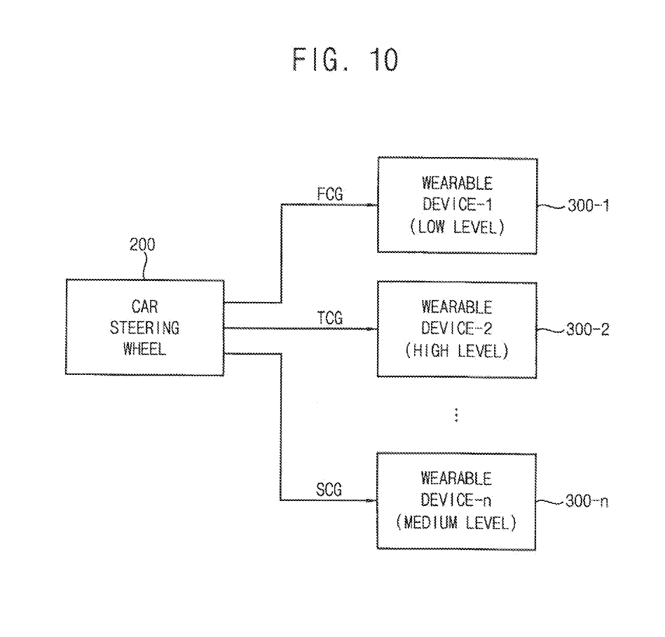

FIG. 9 is a flowchart illustrating an example in which the wireless charging systems of FIG. 1 sequentially charge a plurality of wearable devices 300 based on the remaining battery levels of batteries included in the wearable devices 300. FIG. 10 is a diagram illustrating an example in which the wireless charging systems of FIG. 1 sequentially charge a plurality of wearable devices 300 based on the remaining battery levels of batteries included in the wearable devices 300.

Referring to FIGS. 9 and 10, when the car steering wheel 200 sequentially transmits a wireless power signal to target wearable devices 300-1 through 300-n, where n is an integer greater than 1, the car steering wheel 200 may sequentially transmit the wireless power signal to the target wearable devices 300-1 through 300-n according to remaining battery levels of the batteries included in the target wearable devices 300-1 through 300-n. Specifically, the car steering wheel 200 may detect that wearable devices 300 are moved within a maximum charging distance of the car steering wheel 200 (S420) and may select the target wearable devices 300-1 through 300-n from among the wearable devices 300 (S440). Subsequently, the car steering wheel 200 may check the remaining battery levels of the batteries included in the target wearable devices 300-1 through 300-n (S460). Next, the car steering wheel 200 may sequentially transmit the wireless power signal to the target wearable devices 300-1 through 300-n in ascending order of the remaining battery levels of the batteries included in the target wearable devices 300-1 through 300-n (S480). For example, as illustrated in FIG. 10, assuming that a remaining battery level of the battery included in the first target wearable device 300-1 is relatively low (i.e., indicated as LOW LEVEL), a remaining battery level of the battery included in the second target wearable device 300-2 is relatively high (i.e., indicated as HIGH LEVEL), and a remaining battery level of the battery included in the (n)th target wearable device 300-n is relatively medium (i.e., indicated as MEDIUM LEVEL), the car steering wheel 200 may wirelessly transmit the wireless power signal to the first target wearable device 300-1 (i.e., indicated as FCG), may wirelessly transmit the wireless power signal to the (n)th target wearable device 300-n (i.e., indicated as SCG), and then may wirelessly transmit the wireless power signal to the second target wearable device 300-2 (i.e., indicated as TCG). In brief, when the car steering wheel 200 sequentially charges the batteries of the target wearable devices 300-1 through 300-n, the car steering wheel 200 may preferentially charge a battery of the target wearable device 300-k having a relatively low remaining battery level (i.e., charging the battery of the target wearable device 300-k is the most urgent), where k is an integer between 1 and n. However, a way that the car steering wheel 200 determines an order of transmitting the wireless power signal to the target wearable devices 300-1 through 300-n is not limited thereto.

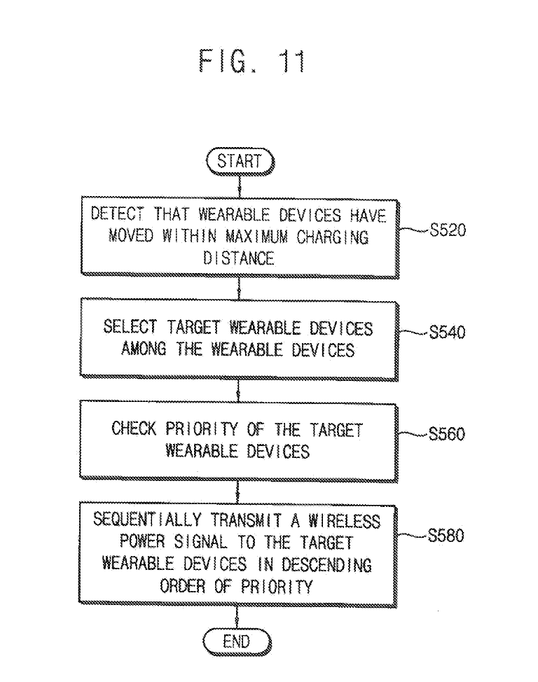

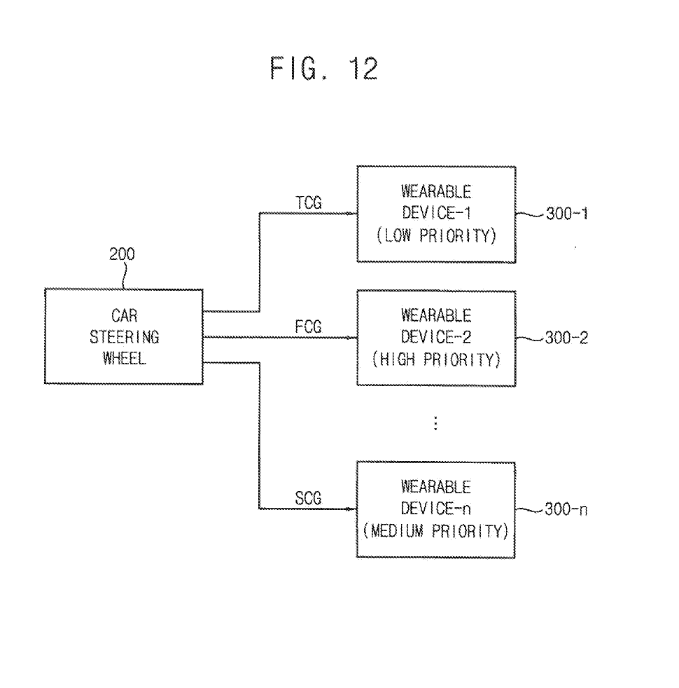

FIG. 11 is a flowchart illustrating an example in which the wireless charging systems of FIG. 1 sequentially charge a plurality of wearable devices 300 based on a priorities of the wearable devices 300. FIG. 12 is a diagram illustrating an example in which the wireless charging systems of FIG. 1 sequentially charges a plurality of wearable devices 300 based on the priorities of the wearable devices 300.

Referring to FIGS. 11 and 12, when the car steering wheel 200 sequentially transmits a wireless power signal to target wearable devices 300-1 through 300-n, the car steering wheel 200 may sequentially transmit the wireless power signal to the target wearable devices 300-1 through 300-n according to a priority of the target wearable devices 300-1 through 300-n. Specifically, the car steering wheel 200 may detect that the wearable devices 300 have moved within a maximum charging distance of the car steering wheel 200 (S520) and may select the target wearable devices 300-1 through 300-n among the wearable devices 300 (S540). Subsequently, the car steering wheel 200 may check the priority of the target wearable devices 300-1 through 300-n (S560). Next, the car steering wheel 200 may sequentially transmit the wireless power signal to the target wearable devices 300-1 through 300-n in descending order of the priority of the target wearable devices 300-1 through 300-n to (S580). For example, as illustrated in FIG. 12, assuming that a priority of the first target wearable device 300-1 is relatively low (i.e., indicated as LOW PRIORITY), a priority of the second target wearable device 300-2 is relatively high (i.e., indicated as HIGH PRIORITY), and a priority of the (n)th target wearable device 300-n is relatively medium (i.e., indicated as MEDIUM PRIORITY), the car steering wheel 200 may wirelessly transmit the wireless power signal to the second target wearable device 300-2 (i.e., indicated as FCG), may wirelessly transmit the wireless power signal to the (n)th target wearable device 300-n (i.e., indicated as SCG), and then may wirelessly transmit the wireless power signal to the first target wearable device 300-1 (i.e., indicated as TCG). In brief, when the car steering wheel 200 sequentially charges the batteries of the target wearable devices 300-1 through 300-n, the car steering wheel 200 may preferentially charge a battery of the target wearable device 300-k having a relatively high priority, where k is an integer between 1 and n. However, a way that the car steering wheel 200 determines an order of transmitting the wireless power signal to the target wearable devices 300-1 through 300-n is not limited thereto.

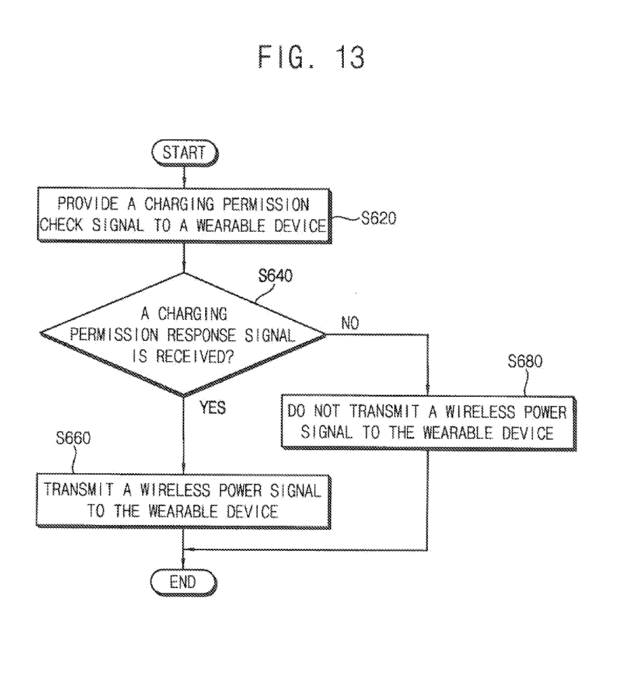

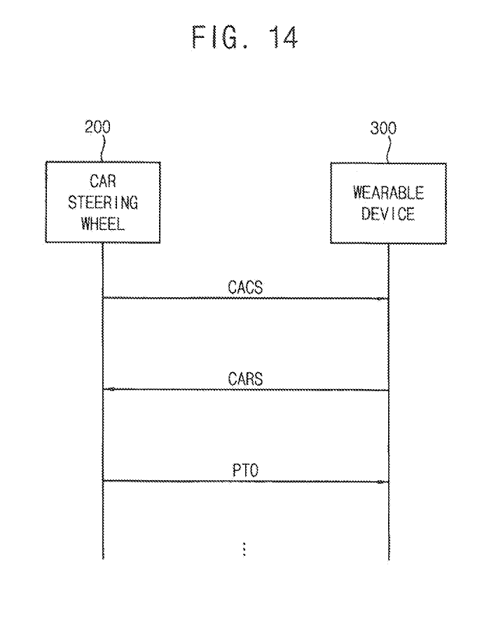

FIG. 13 is a flowchart illustrating an example in which the wireless charging systems of FIG. 1 selectively charge a plurality of wearable devices 300. FIG. 14 is a diagram illustrating an example in which the wireless charging systems of FIG. 1 selectively charge a plurality of wearable devices 300.

Referring to FIGS. 13 and 14, after the car steering wheel 200 provides a charging permission check signal CACS to the wearable device 300, the car steering wheel 200 may wirelessly transmit a wireless power signal PTO to the wearable device 300 when a charging permission response signal CARS is received from the wearable device 300. Specifically, the car steering wheel 200 may provide the charging permission check signal CACS to the wearable device 300 (S620) when the wearable device 300 is moved within a maximum charging distance of the car steering wheel 200. Next, the car steering wheel 200 may check whether the charging permission response signal CARS has been received from the wearable device 300 (S640). Here, when the charging permission response signal CARS has been received from the wearable device 300, the car steering wheel 200 may wirelessly transmit the wireless power signal PTO to the wearable device 300 (S660). On the other hand, when the charging permission response signal CARS has not been received from the wearable device 300, the car steering wheel 200 may not wirelessly transmit the wireless power signal PTO to the wearable device 300 (S680). As a result, the car steering wheel 200 may wirelessly transmit the wireless power signal PTO to the wearable device 300 having charging permission. For example, when a user wearing the wearable device 300 gets in a car, the car steering wheel 200 may check whether the wearable device 300 is registered to have charging permission and may charge a battery of the wearable device 300 when the wearable device 300 is registered to have charging permission. For example, when a user wearing the wearable device 300 gets in a transportation vehicle (e.g., bus, taxi, subway, etc), the car steering wheel 200 may check whether the wearable device 300 has made a payment to have charging permission and may charge a battery of the wearable device 300 when the wearable device 300 has made the payment to have charging permission. However, a way that the car steering wheel 200 determines whether to charge a battery of the wearable device 300 is not limited thereto.

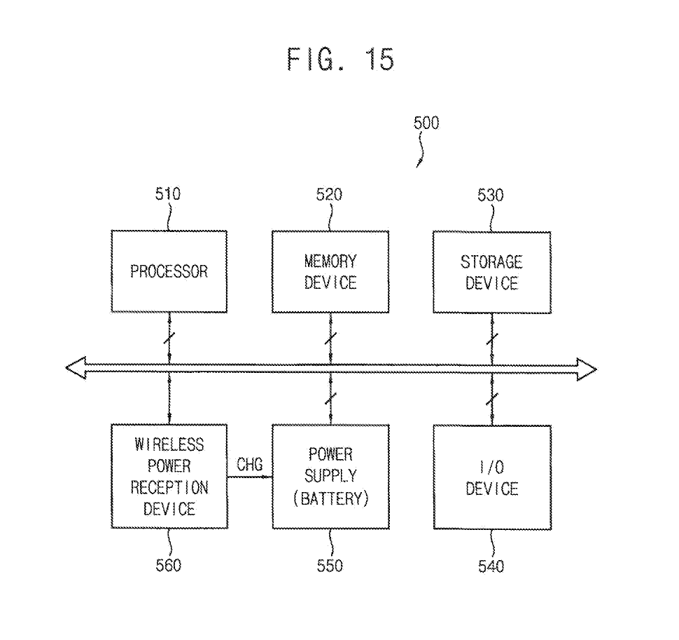

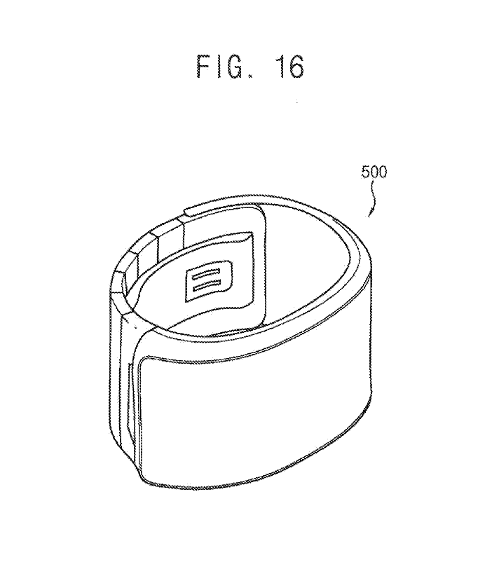

FIG. 15 is a block diagram illustrating wearable devices according to example embodiments of the present inventive concepts. FIG. 16 is a diagram illustrating an example in which the wearable devices of FIG. 15 are implemented as a smart watch.

Referring to FIGS. 15 and 16, the wearable devices 500 may include a processor 510, a memory device 520, a storage device 530, an input/output (I/O) device 540, a power supply 550, and a wireless power reception device 560. In addition, the wearable device 500 may further include a plurality of ports for communicating with, for example, a video card, a sound card, a memory card, a universal serial bus (USB) device, other electronic devices, etc.

In example embodiments of the present inventive concepts, as illustrated in FIG. 16, the wearable device 500 may be implemented as a smart watch that a user wears (e.g., on the wrist). However, the wearable device 500 is not limited thereto. For example, the wearable device 500 may be implemented as a headset, glasses, etc as well as the smart watch. That is, the wearable device 500 should be interpreted as a portable electronic device that the user can wear.

The processor 510 may perform various computing functions. The processor 510 may be, for example, a micro-processor, a central processing unit (CPU), an application processor (AP), etc. The processor 510 may be coupled to other components via, for example, an address bus, a control bus, a data bus, etc. In some example embodiments of the present inventive concepts, the processor 510 may be coupled to an extended bus such as a peripheral component interconnection (PCI) bus. The memory device 520 may store data for operations of the wearable device 500. For example, the memory device 520 may include a volatile semiconductor memory device such as a dynamic random access memory (DRAM) device, a static random access memory (SRAM) device, a mobile DRAM, etc, and a non-volatile semiconductor memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. The storage device 530 may include a solid state drive (SSD) device, a hard disk drive (HDD) device, a CD-ROM device, etc.

The I/O device 540 may include an input device such as a keyboard, a keypad, a touchpad, a touch-screen, a mouse device, etc, and an output device such as a display device, a printer, a speaker, etc. The power supply 550 may provide power for operations of the wearable device 500. Here, the power supply 550 may include a battery. The wireless power reception device 560 may be coupled to other components via the buses or other communication links. As described above, the wireless power reception device 560 may include a second matching unit 321, a voltage conversion unit 322, a battery charging unit 323, and a wireless power signal reception control unit 324. The second matching unit 321 may wirelessly receive a wireless power signal from a wireless power transmission device 220 included in a car steering wheel 200. The voltage conversion unit 322 may convert the wireless power signal (i.e., AC signal) received from the second matching unit 321 into a DC signal for the battery charging unit 323 to charge the battery of the power supply 550. The battery charging unit 323 may charge the battery of the power supply 550 based on the DC signal received from the voltage conversion unit 322. The wireless power signal reception control unit 324 may control the second matching unit 321, the voltage conversion unit 322, and the battery charging unit 323. Since the wireless power reception device 560 is described above, a duplicate description will not be repeated. On this basis, the wearable device 500 may enable the battery of the power supply 550 to be automatically charged (i.e., indicated as CHG) when the user gets in a car (or, vehicle). To this end, the wireless power reception device 560 included in the wearable device 500 may communicate with the wireless power transmission device 220 included in the car steering wheel 200.

The present inventive concepts may be applied to portable electronic devices employing a wireless charging technology. For example, the present inventive concepts may be applied to a smart watch, a cellular phone, a smart phone, a smart pad, a tablet PC, a personal digital assistants (PDA), a portable multimedia player (PMP), a car navigation system, an MP3 player, a computer, a laptop, a digital camera, etc.

The foregoing is illustrative of example embodiments of the present inventive concepts and is not to be construed as limiting thereof. Although a few example embodiments have been described, those skilled in the art will readily appreciate that many modifications are possible in the example embodiments without materially departing from the novel teachings and advantages of the present inventive concepts. Accordingly, all such modifications are intended to be included within the scope of the present inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A wireless charging system comprising:
a steering wheel including a wireless power transmission device configured to wirelessly transmit a wireless power signal based on a magnetic resonance technique or based on a magnetic induction technique; and
a wearable device including a wireless power reception device configured to receive the wireless power signal in order to charge a battery included in the wearable device.

2. The wireless charging system of claim 1, wherein the wearable device is implemented as a smart watch that a user wears.

3. The wireless charging system of claim 1, wherein the wearable device is configured to provide a battery condition signal indicating a remaining battery level of the battery to the steering wheel, and
wherein the wireless power transmission device is configured to wirelessly transmit the wireless power signal to the wearable device when the remaining battery level of the battery is lower than a reference battery level.

4. The wireless charging system of claim 3, wherein the reference battery level is set to be a maximum battery level of the battery.

5. The wireless charging system of claim 1, wherein the wearable device is configured to provide a charging completion signal to the steering wheel when charging of the battery is completed, and
wherein the wireless power transmission device is configured to not wirelessly transmit the wireless power signal to the wearable device when the charging completion signal is received from the wearable device.

6. The wireless charging system of claim 1, wherein the wireless power transmission device is configured to wirelessly transmit the wireless power signal to the wearable device based on the magnetic resonance technique when a distance between the steering wheel and the wearable device is greater than a reference distance.

7. The wireless charging system of claim 6, wherein the wireless power transmission device is configured to wirelessly transmit the wireless power signal to the wearable device based on the magnetic induction technique when the distance between the steering wheel and the wearable device is shorter than the reference distance.

8. The wireless charging system of claim 7, wherein the reference distance is set to a distance between the steering wheel and the wearable device at a time when a user wearing the wearable device grips the steering wheel.

9. The wireless charging system of claim 1, wherein the wireless power transmission device is configured to wirelessly transmit the wireless power signal to the wearable device when a charging permission response signal is received from the wearable device responsive to a charging permission check signal provided by the wireless power transmission device to the wearable device.

10. The wireless charging system of claim 1, wherein the wearable device is a plurality of wearable devices, and
wherein the wireless power transmission device is configured to wirelessly transmit the wireless power signal to target wearable devices that are selected among the plurality of wearable devices.

11. The wireless charging system of claim 10, wherein a number of the target wearable devices is smaller than a maximum number of wearable devices that can be wirelessly charged by the steering wheel.

12. The wireless charging system of claim 10, wherein the wireless power transmission device is configured to simultaneously wirelessly transmit the wireless power signal to the target wearable devices.

13. The wireless charging system of claim 10, wherein the wireless power transmission device is configured to sequentially wirelessly transmit the wireless power signal to the target wearable devices.

14. The wireless charging system of claim 13, wherein the wireless power transmission device is configured to sequentially wirelessly transmit the wireless power signal to the target wearable devices in ascending order of remaining battery levels of batteries included in the target wearable devices.

15. The wireless charging system of claim 13, wherein the wireless power transmission device is configured to sequentially wirelessly transmit the wireless power signal to the target wearable devices in descending order of priorities of the target wearable devices.

16. A wireless charging system comprising:
a steering wheel for a vehicle including a wireless power transmission device configured to wirelessly transmit a wireless power signal to an electronic device, said wireless power transmission device further comprising:
a wireless power signal generation unit configured to generate a power signal for transmission to the electronic device;
a transmission matching unit configured to wirelessly transmit the wireless power signal to the electronic device using a magnetic resonance technique or using a magnetic induction technique; and
a wireless power signal transmission control unit configured to control the wireless power signal generation unit and the transmission matching unit.

17. The wireless charging system of claim 16, wherein the wireless power transmission device is further configured to receive signals from and transmit signals to the electronic device.

18. The wireless charging system of claim 16, wherein the electronic device is a plurality of electronic devices, and
wherein the wireless power transmission device is configured to wirelessly transmit the wireless power signal to target electronic devices that are selected among the plurality of electronic devices.

19. The wireless charging system of claim 18, wherein the wireless power transmission device is configured to simultaneously wirelessly transmit the wireless power signal to the target electronic devices.

20. The wireless charging system of claim 18, wherein the wireless power transmission device is configured to sequentially wirelessly transmit the wireless power signal to the target electronic devices.
